(19) United States
(12) Patent Application Publication
(10) Pub. No.: US 2016/0090079 A1
(43) Pub. Date: Mar. 31, 2016

(54) TRANSMISSION STRUCTURE OF HEV AND METHOD OF MODE CHANGE

(71) Applicant: Hyundai Motor Company, Seoul (KR)

(72) Inventor: Kum Lim Choi, Seoul (KR)

(21) Appl. No.: 14/565,006

(22) Filed: Dec. 9, 2014

(30) Foreign Application Priority Data
Sep. 30, 2014 (KR) 10-2014-0131648

(51) Int. Cl. B60W 20/00; B60W 10/08; B60W 10/06; F16H 37/06; B60K 6/445

(52) U.S. Cl. CPC B60W 20/40; F16H 37/065; B60K 6/445; B60W 10/06; B60W 10/08; B60W 2510/083; Y10S 903/93

(57) ABSTRACT

A transmission structure of an HEV including: a generator disposed on the same shaft as an engine input shaft and coupled with a sun gear of a planetary gear part; a brake coupled with the sun gear or the generator; a rotation limiter to selectively limit a rotation of the engine input shaft; a first counter shaft connected to a motor disposed on the same shaft as the engine input shaft to transfer power; a second counter shaft connected to a ring gear included in the planetary gear part to transfer power; and an output shaft connected to the first counter shaft and the second counter shaft to transfer power to a wheel.

### CROSS-REFERENCE TO RELATED APPLICATION

This application is based on and claims the benefit of priority to Korean Patent Application No. 10-2014-0131648, filed on Sep. 30, 2014 in the Korean Intellectual Property Office, the disclosure of which is incorporated herein in its entirety by reference.

### TECHNICAL FIELD

The present disclosure relates to a transmission structure of a hybrid electric vehicle (HEV) and a method of a mode change thereof, and more particularly, to a transmission structure capable of preventing a phenomenon of power interruption or the occurrence of shock at the time of changing a power split mode of a transmission of an HEV to a parallel mode.

### BACKGROUND

Generally, a hybrid electric vehicle (HEV) is a vehicle which is driven by a combination of a power source of electricity and a power source of an internal combustion engine. The HEV is controlled at a point where the gasoline engine and the electric motor operate at high efficiency, thereby efficiently reducing exhaust gas while maintaining performance.

Further, the hybrid electric vehicle may enhance fuel efficiency and secure a driving distance equal to that of the typical gasoline vehicle without needing to build a separate charging facility. Thus, the electric vehicle is expected to be a mainstay of future environmentally-friendly vehicles.

For the HEV, a power split method is configured having a mechanical flow which uses a power split apparatus. The power split apparatus splits a power flow, such as by a planetary gear, to directly transfer power of an engine to an output shaft. An electrical flow uses the power of the engine to power a generator and charge a battery using the generated power or drive a motor with the energy of the charged battery.

The power split method based HEV system may operate the engine independent of the output shaft, freely turn the combustion engine on and off while the vehicle is driven, and implement an electric vehicle mode.

However, the related art has a problem in that power may be interrupted or a shock may occur, at the time of changing the mode of the transmission of the HEV.

### RELATED ART DOCUMENT

Patent 1: Korean Patent Laid-Open Publication No. 10-2014-0080638, which is incorporated herein by reference.

### SUMMARY

The present disclosure has been made to solve the above-mentioned problems occurring in the prior art while the advantages achieved by the prior art are maintained intact.

An aspect of the present disclosure provides a transmission structure of a hybrid electric vehicle (HEV) and a method of a mode change thereof. The structures and methods are capable of preventing a phenomenon of power interruption and/or the occurrence of shock at the time of changing a power split mode of a transmission of an HEV to a parallel mode.

According to an exemplary embodiment of the present disclosure, a transmission structure of an HEV includes a generator disposed on the same shaft as an engine input shaft and coupled with a sun gear of a planetary gear part. A brake is coupled with the sun gear or the generator. A rotation limiter selectively limits a rotation of the engine input shaft. A first counter shaft is connected to a motor disposed on the same shaft as the engine input shaft to transfer power. A second counter shaft is connected to a ring gear included in the planetary gear part to transfer power. An output shaft is connected to the first counter shaft and the second counter shaft to transfer power to a wheel.

Another brake may be applied as the rotation limiter. The first counter shaft, the second counter shaft, and the output shaft may be connected to one another by an external gear.

According to an exemplary embodiment of the present disclosure, a method of a mode change of a transmission of an HEV includes in the transmission of the HEV, a first step of determining that a power split mode of the transmission is changed to a parallel mode. A second step is determining whether a driving force of a motor disposed on the same shaft as an engine input shaft is sufficient during changing to the parallel mode. A third step is setting an engine torque to be ‘0’ when the driving force of the motor is sufficient in the second step to control an engine speed. A fourth step is allowing a generator disposed on the same shaft as the engine input shaft to control the engine speed when the driving force of the motor is insufficient in the second step.

When the driving force of the motor is insufficient in the second step, the fourth step may include a preparatory step of determining whether the generator controls the engine speed before the generator controls the engine speed.

If it is determined in the preparatory step that the generator controls the engine speed, the process may proceed to the fourth step. If it is determined in the preparatory step that the generator may not control the engine speed, the process may proceed to a another step that reduces an engine torque and increases a torque of the motor.

It should be appreciated that the subject technology can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

The above and other objects, features and advantages of the present disclosure will be more apparent from the following detailed description taken in conjunction with the accompanying drawings.

FIG. 1 is a schematic diagram illustrating a transmission structure of a hybrid electric vehicle (HEV) according to an exemplary embodiment of the present disclosure.

FIG. 2 is a schematic diagram illustrating an EV mode in the transmission structure of the HEV according to the exemplary embodiment of the present disclosure.

FIG. 3 is a schematic diagram illustrating a power split mode in the transmission structure of the HEV according to the exemplary embodiment of the present disclosure.

FIG. 4 is a schematic diagram illustrating an engine direct connection mode in the transmission structure of the HEV according to the exemplary embodiment of the present disclosure.

FIG. 5 is a flow chart illustrating a mode conversion method of a transmission of an HEV according to an exemplary embodiment of the present disclosure.

FIG. 6 is a graph illustrating a speed control after an engine torque is set to be ‘0’ in the mode conversion method of the transmission of the HEV according to the exemplary embodiment of the present disclosure.

FIG. 7 is a graph illustrating a speed control by a motor in the mode conversion method of the transmission of the HEV according to the exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although an exemplary embodiment is described as using a plurality of units to perform the exemplary process, it is understood that the exemplary processes may also be performed by one or plurality of modules or units that are combined and arranged into fewer or more parts that provide the same functional advantages. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present disclosure will be described below in detail with reference to the accompanying drawings.

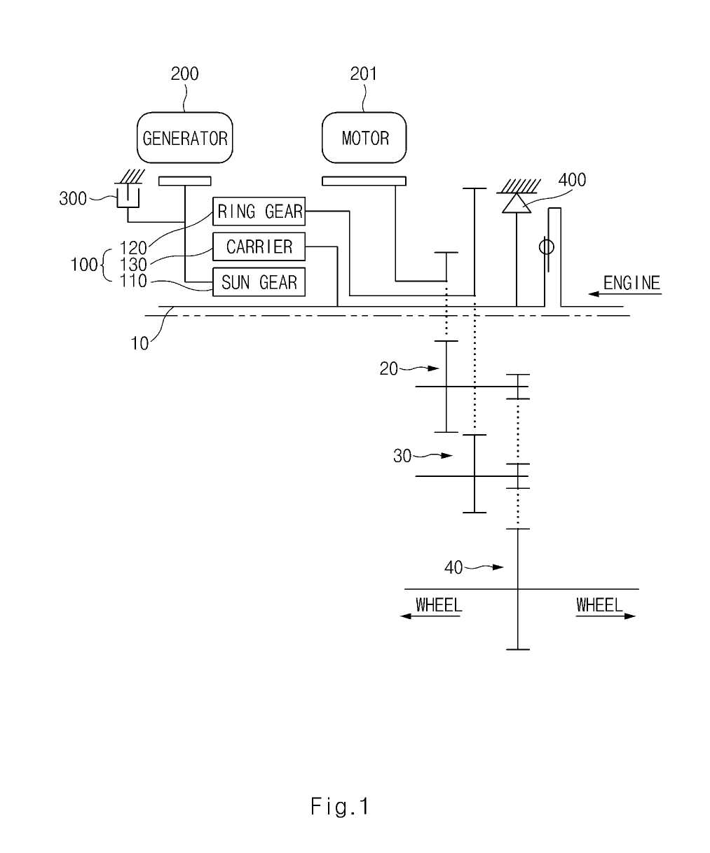

As illustrated in FIGS. 1 to 3, a transmission structure of a hybrid electric vehicle (HEV) according to an exemplary embodiment of the present disclosure includes a generator 200 coupled with a sun gear 110 of a planetary gear part 100. A brake 300 is coupled with the sun gear 110 or the generator 200. A rotation limiter 400 limits a rotation of an input shaft 10. A first counter shaft 20 connects to a motor 201 and a second counter shaft 30 connects to a ring gear 120. An output shaft 40 connects to the first counter shaft 20 and the second counter shaft 30.

The present disclosure can change from a power split mode of the transmission of an HEV to a parallel mode based on the fact that the generator 200, the motor 201, and the planetary gear part 100 are disposed on the same shaft as the engine input shaft 10. In this configuration, the planetary gear part 100 includes the ring gear 120, a carrier 130, and the sun gear 110.

As illustrated in FIG. 1, the generator 200 is disposed on the same shaft as the engine input shaft 10 and coupled with the sun gear 110 of the planetary gear part 100, thereby controlling a shift ratio.

The brake 300 is coupled with the sun gear 110 or the generator 200 to perform braking. In this case, the brake 300 is an over drive brake.

The rotation limiter 400 selectively limits the rotation of the engine input shaft 10.

Another brake, other than the brake 300, may be preferably applied. The rotation limiter 400 may be a one-way clutch (OWC) or a two-way clutch (TWC).

Further, the exemplary embodiment of the present disclosure includes a plurality of counter shafts 20, 30 and one output shaft 40, each of which transfers power.

The first counter shaft 20 is connected to the motor 201 which is disposed on the same shaft as the engine input shaft 10 to transfer the power of the motor 201.

The second counter shaft 30 is connected to the ring gear 120 included in the planetary gear part 100 to transfer power.

The output shaft 40 is connected to the first counter shaft 20 and the second counter shaft 30 to transfer power to a wheel (not shown).

In this case, the first counter shaft 20, the second counter shaft 30, and the output shaft 40 are connected to one another by an external gear to facilitate the power transfer.

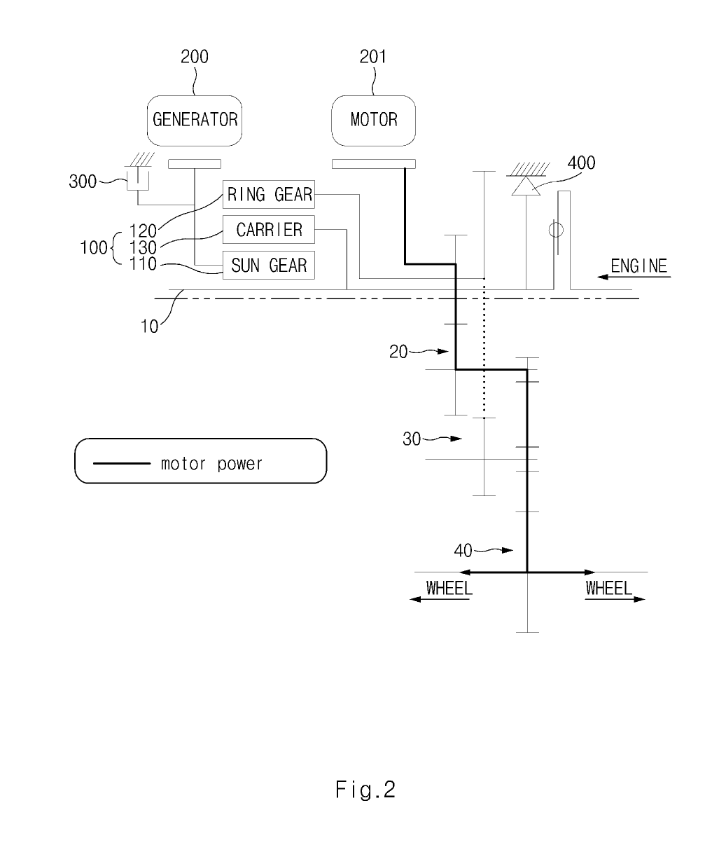

As described above, according to the exemplary embodiment of the present disclosure, the generator 200, the motor 201, and the plurality of brakes are disposed on the input shaft 10 in the structure in which an input split and parallel driving may be made to implement different modes as shown in Table 1 below depending on the brake (see FIGS. 2 to 4) .

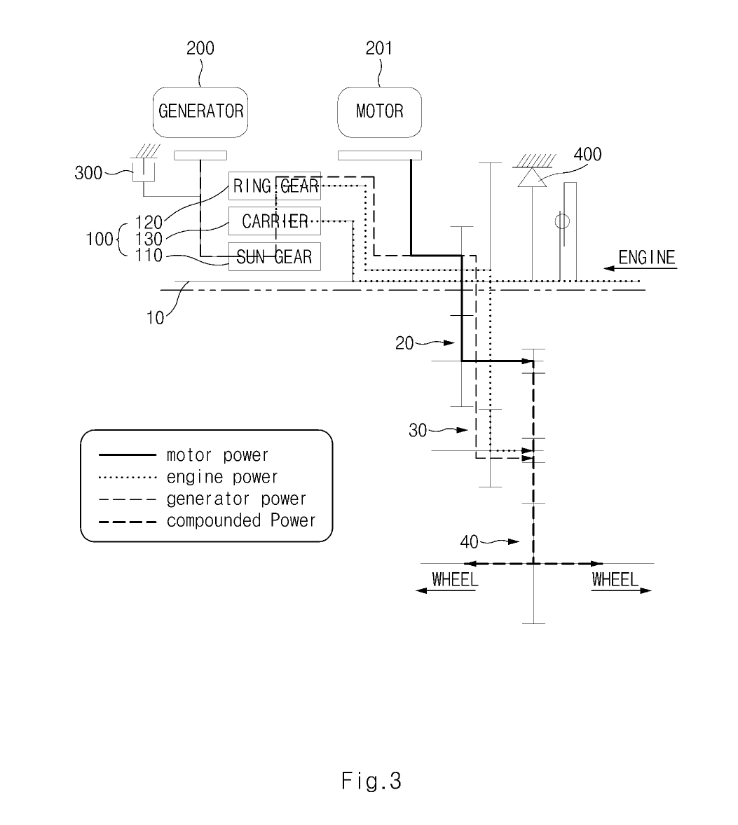

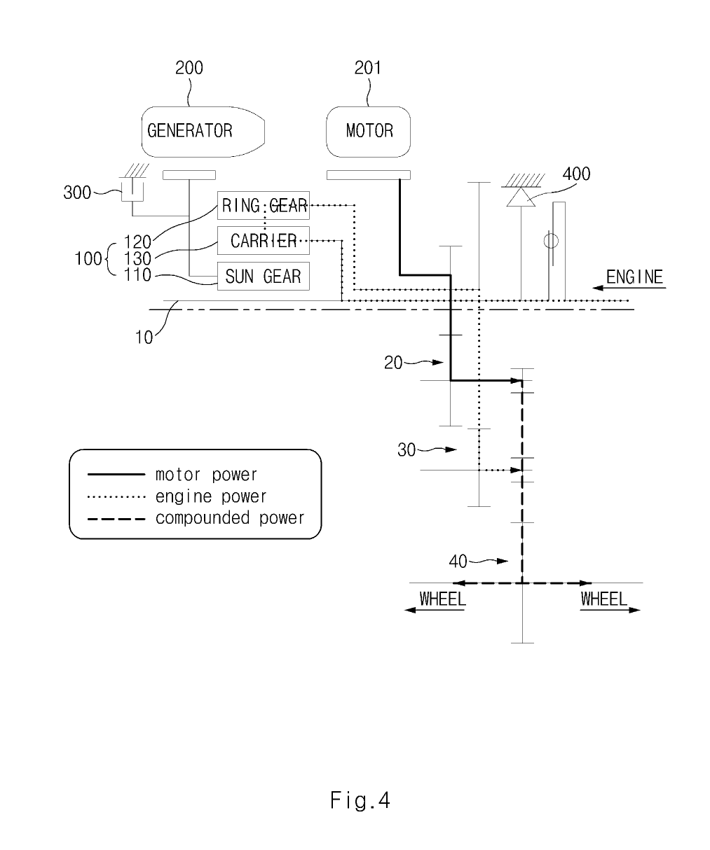

TABLE 1

| Mode | OWC, TWC, Brake | ODB | Description |
|---|---|---|---|
| EV (FIG. 2) | ◯ | | Implement EV mode (Drive |
| | | | motor) |
| HEV1 (FIG. 3) | | | Drive input splitting |
| | | | system |
| HEV2 (FIG. 4) | | ◯ | Implement high-speed |
| | | | fixed stage gear (OD) |

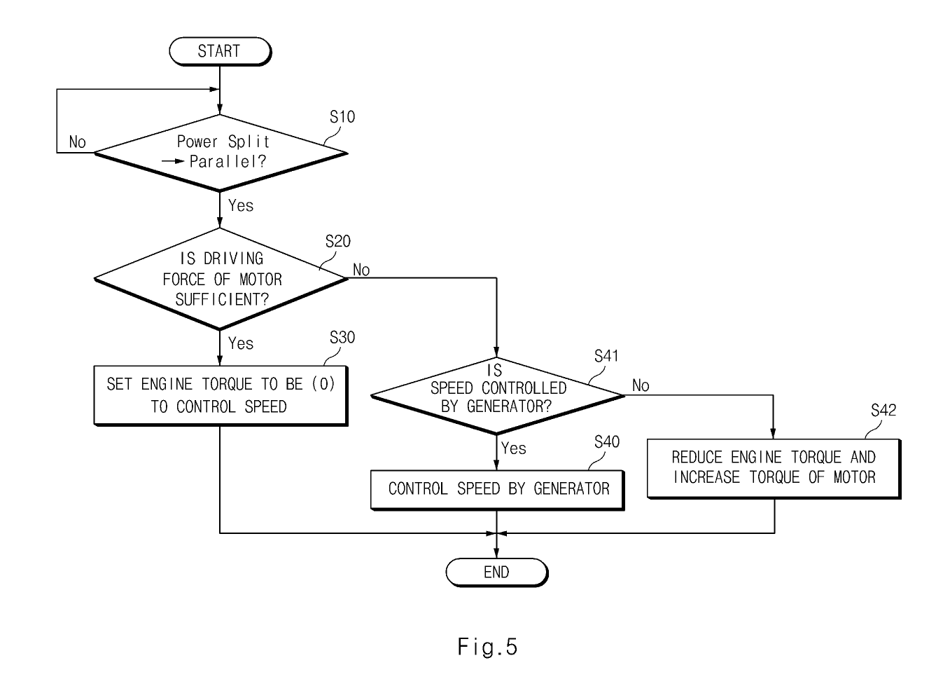

Referring now to FIGS. 5 to 7, once started, the mode conversion method of the transmission of the HEV according to the exemplary embodiment of the present disclosure includes a first step (S10) of determining whether the power split mode of the transmission of the HEV is changed to the parallel mode. If not, the method loops back and continues to check. If the power split mode is changed to parallel mode, the method proceeds to step (S20).

The second step (S20) determines a driving force of the motor 201. If the driving force is sufficient, the method proceeds to step (S30). If the driving force is insufficient, the method proceeds to step (S41).

The third step (S30) and a fourth step (S40) relate to controlling the engine speed. The following description is with respect to a configuration of the transmission structure of the HEV shown in FIGS. 1 to 4.

As illustrated in FIG. 5, in the first step (S10), the method determines whether the power split mode is changed to the parallel mode. If so, the method proceeds to step (S20).

In the second step (S20), the method determines whether the driving force of the motor 201 disposed on the same shaft as the engine input shaft 10 is sufficient while the mode of the transmission of the HEV is changed to the parallel mode in the first step (S10). If it is determined that the driving force is sufficient, the process proceeds to the third step (S30). If it is determined that the driving force is insufficient, the process may proceed to the fourth step (S40).

In the third step (S30), when the driving force of the motor 201 is sufficient in the second step (S20), the engine torque is set to be ‘0’ to control the engine speed.

In the fourth step (S40), when the driving force of the motor 201 is insufficient in the second step (S20), the generator 200 disposed on the same shaft as the engine input shaft 10 controls the engine speed.

In this case, when the driving force of the motor 201 is insufficient in the second step (S20), the fourth step (S40) preferably includes a preparatory step (S41) of determining whether the generator 200 may control the engine speed before the generator 200 controls the engine speed.

Further, if it is determined in the preparatory step (S41) that the generator 200 may control the engine speed, the process proceeds to the fourth step (S40). If it is determined in the preparatory step (S41) that the generator 200 may not control the engine speed, the process preferably proceeds to step (S42) that reduces the engine torque and increases the torque of the motor 201.

That is, according to the exemplary embodiment of the present disclosure, first, it is determined whether the mode change from the power split mode of the vehicle to the parallel mode is performed. The controller (not shown) calculates and compares efficiency for each driving mode using required power of a driver, vehicle speed, and the like.

Still referring to FIG. 5, at step (S20), it is determined whether an available driving force of the motor 201 is sufficient. If the available driving force of the motor 201 is larger than the required power of the driver, the engine torque is set to be 0 to control the engine speed at step (S30).

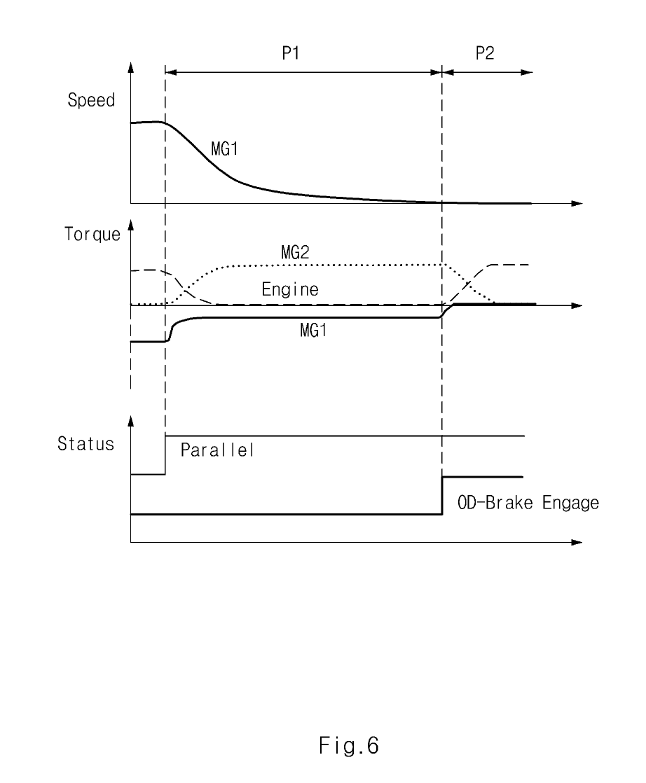

Referring to FIG. 6, when the available driving force of the motor 201 is larger than the required power of the driver, if it is determined that the mode is the parallel mode, torque blending is performed so as to allow the motor 201 to generate the torque which is generated by the engine. Therefore even though the engine torque is set to be 0, the driving force of the vehicle is constant. Only the engine torque having the same size as an engine friction is generated by reducing an engine air volume to make the engine torque be set to be 0. Next, a negative torque is generated in the generator 200 to control the engine speed. By doing so, since the engine torque is 0, power is not transferred to the driving shaft due to the control of the engine speed, and thus the speed control may be smoothly performed.

Still referring to FIG. 6, when the engine torque is set to be 0, a fuel cut may be performed. In this case, an engine friction torque is applied to the engine and the engine speed is reduced even though the negative torque is not applied to the generator 200. However, when the speed of the generator 200 is 0, the brake 300 needs to be operated. In this case, since the friction torque is applied to the engine, the shock corresponding to the friction torque may occur due to the driving force. To prevent this, the generator 200 needs to perform additional repulsive power control. Further, when the brake 300 is operated at a portion which the speed of the generator 200 is 0, the shock occurs in the vehicle due to the rotation inertia of the engine. In this case, the generator 200 may be controlled to smoothly approach 0. Here, the generated torque allows the motor 201 to perform the repulsive power control.

As such, when the available driving force of the motor 201 is sufficient, one of the two methods as described above may be selected and the two methods may be appropriately combined and used.

However, when the available driving force of the motor 201 is not sufficient, it is determined whether the engine speed may be controlled by the generator 200. In this case, when the generator 200 intends to control the engine speed, a repulsive power torque of the engine and a torque for controlling the engine speed are required. When a repulsive power torque of the engine of the generator 200 is large in the situation in which the engine torque is large, since the available torque of the generator 200 for the speed control is relatively small, the speed control is performed with the small torque and thus it takes much time to perform the speed control. Therefore, it is determined that the available torque of the generator 200 is sufficient to allow the generator 200 to perform the speed control.

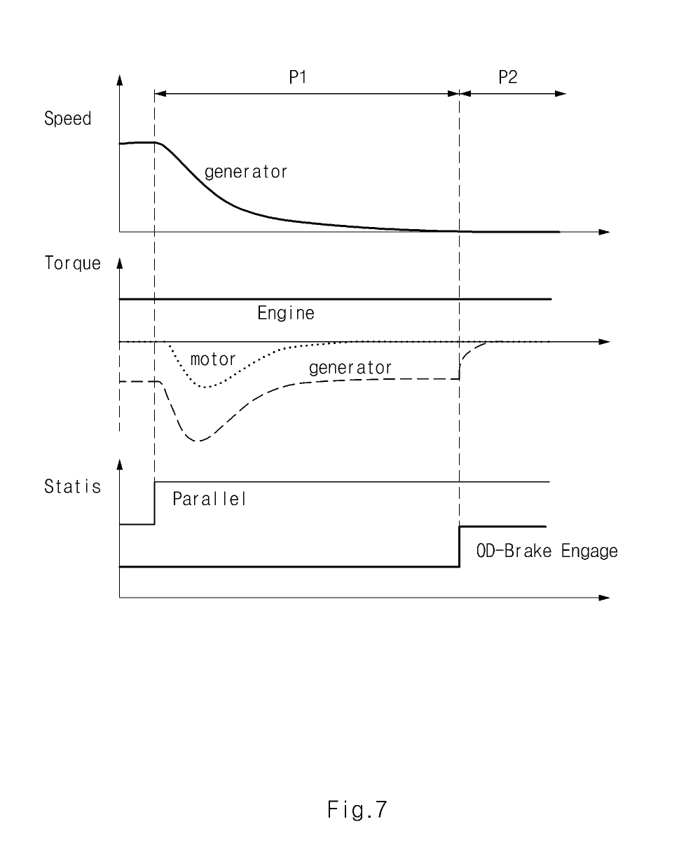

As illustrated in FIG. 7, when the generator 200 may control the engine speed, the engine torque is maintained substantially constant and the generator 200 controls the engine speed. The torque generated when the generator 200 reduces the engine speed affects the driving shaft, and therefore the motor 201 performs the repulsive power control as much as the corresponding torque. In this case, the engine may be maintained at a high torque, such that the engine efficiency is increased and the generation of the exhaust gas due to the change in injection is prevented.

In this case, when the generator 200 may not control the engine speed, the generator 200 reduces the engine torque to control the engine speed (when the engine torque is reduced, the repulsive power torque of the engine of the generator 200 is reduced and therefore the available torque for the speed control is increased). Further, the motor 201 generates a torque as much as the engine torque reduced to make the driving force be the same.

When the generator 200 controls the engine speed, and the torque generated when the generator 200 reduces the engine speed affects the driving shaft, the motor 201 performs the repulsive power control as much as the corresponding torque.

As can be seen from the above, the present technology appropriately controls the brake 300, the engine, the generator 200, and the motor 201 to prevent the phenomenon of power interruption or the occurrence of shock at the time of changing the power split mode of the transmission of the HEV to the parallel mode, thereby enhancing the fuel efficiency and the marketability.

As described above, according to the exemplary embodiments of the present disclosure, it is possible to enhance the fuel efficiency, ride and the marketability of the vehicle by preventing the phenomenon of power interruption or the occurrence of shock at the time of changing the power split mode of the transmission of the HEV to the parallel mode by appropriately controlling the brake, the engine, the generator, and the motor.

As described above, although the present invention has been described with reference to exemplary embodiments and the accompanying drawings, it would be appreciated by those skilled in the art that the present invention is not limited thereto but various modifications and alterations might be made without departing from the scope defined in the following claims.

1. A transmission structure of a hybrid electric vehicle (HEV), comprising:
a generator disposed on a same shaft as an engine input shaft and coupled with a sun gear of a planetary gear part;
a brake coupled with the sun gear or the generator;
a rotation limiter to selectively limit a rotation of the engine input shaft;
a first counter shaft connected to a motor disposed on the same shaft as the engine input shaft to transfer power;
a second counter shaft connected to a ring gear included in the planetary gear part to transfer power; and
an output shaft connected to the first counter shaft and the second counter shaft to transfer power to a wheel,
wherein the first counter shaft and the second counter shaft are connected to the output shaft in parallel.

2. The transmission structure of an HEV according to claim 1, wherein another brake is applied.

3. The transmission structure of an HEV according to claim 1, wherein the first counter shaft, the second counter shaft, and the output shaft are connected to one another by an external gear.

4. A method of a mode change in a transmission of a hybrid electric vehicle (HEV), the method comprising the steps of:
determining that a power split mode is changed to a parallel mode;
determining whether a driving force of a motor disposed on the same shaft as an engine input shaft of an engine is sufficient during changing to the parallel mode;
setting an engine torque to be ‘0’ when the driving force of the motor is sufficient to control an engine speed; and
allowing a generator disposed on the same shaft as the engine input shaft to control the engine speed when the driving force of the motor is insufficient.

5. The method according to claim 4, wherein when the driving force of the motor is insufficient, determining whether the generator controls the engine speed before the generator controls the engine speed.

6. The method according to claim 5, wherein when the generator does not control the engine speed, reducing the engine torque and increasing a torque of the motor.
